(19) United States
(12) Patent Application Publication
(10) Pub. No.: US 2001/0049692 A1
(43) Pub. Date: Dec. 6, 2001

(54) Method of maximizing undergraduate and postgraduate education enrollments

(76) Inventors: Frank R. Callaghan, Ridgewood, NJ (US); Hal G. Wirth, Dix Hills, NY (US)

Correspondence Address: Frank R. Callaghan, 337 Fairway Road, Ridgewood, NJ, 07450, US

(21) Appl. No.: 09/837,396

(22) Filed: Apr. 18, 2001

Related U.S. Application Data
(60) Provisional application No. 60/199,061, filed on Apr. 20, 2000.

(51) Int. Cl. G06F 17/30

(52) U.S. Cl. 707/104.1; 707/1

(57) ABSTRACT

A computerized system and method of optimizing enrollments for educators while providing a cost effective post-secondary school education is described. Pools of prospective students and educational institutions are created and made accessible to registered users via an electronic medium such as a computer connected to the Internet. Registered prospective students are matched to educational institutions offering discounted tuition rates. The students are provided with cost effective education and the educational institutions optimize enrollment through offering discounted tuition rates. Financial return from enrollments for the educational institutions is maximized by the increase of enrollment due to the discounted tuition rate and access to a pool of prospective students.

### BACKGROUND OF THE INVENTION

1. Field of the Invention

This invention generally relates to a computerized system and method for enhancing enrollment and delivering cost effective education in post-secondary schools and more particularly relates to a system and method of providing discounted tuition rates.

2. Description of Related Art

Increasing college costs are a reality which has both the post-secondary institutions and prospective students concerned. Many institutions are concerned that the rising tuition rates are perilously close to pricing the institutions out of an increasingly competitive market. Cost savings opportunities are often high on the list of programs for these higher educational institutions. Many institutions have turned to downsizing or eliminating services at the college or university. These cost saving activities too often affect the quality and quantity of student services and programs. For the prospective students, the cost of a higher education and its benefit in an extremely competitive work environment is being weighed against each other more than in the past. Prospective students are turning to alternative career paths such as entering the military or becoming self employed rather than face the growing tuition rates.

No one disagrees that the cost of obtaining a post-secondary education has risen dramatically in the last twenty years. For example, according to the National Commission on the Cost of Higher Education (1998), since the early 1980s, college tuition has increased annually at two to three times the rate of inflation. Between 1981 and 1995, tuition at 4-year public colleges and universities increased 234%, while during the same time period, median household financial return rose 82% and the consumer price index rose only 74%. The typical bill for tuition, fees, room, board, books and incidentals at public institutions is $10,069. The problem is not restricted to public institutions. At one Ivy League institution, tuition in 1976 was $3,790. Two decades later that tuition bill was $21,130, nearly a six fold increase.

In response to the rising tuition rates, there have been legislative recommendations to the colleges to increase their efforts to contain and cut costs. However, cost reduction by decreasing services at the institutions often result in a drop in enrollment and a decrease in the quality of education.

Responses to deal with the rising costs of tuition have varied and have had limited success. For example, some responses have included government sponsored incentives (e.g., Education IRAs) to encourage families to start saving early for college, institution based programs (e.g. prepaid tuition plans which lock in tuition rates at current levels), and federal and state loan programs and other financial aid. However, these programs still do not fully address the rising cost in tuition and its effect on decreased enrollments. Prospective students using the above methods usually must gather financial aid packages which are complex, difficult to access, and more dependent upon loans than ever before. Too often students are graduating with huge amounts of debt, which strap the student's earnings for 20 years or more.

Therefore, a need exists in the art that would allow students to obtain cost effective post-secondary education without the decrease in services or programs in the educational institution. In addition, a need exists for the institutions to optimize student enrollment and hence financial return in a highly competitive market place without being priced out of the market.

### SUMMARY OF THE INVENTION

The present invention avoids disadvantages enumerated above as well as other disadvantages. One aspect of the invention involves providing a method and system that facilitates interaction between prospective students seeking cost effective solutions for formalized education and educators that are interested in optimizing their enrollments. In one embodiment, separate pools of prospective students and educational institutions are created. These separate pools are accessible to registered users via an electronic medium such as a computer connected to the Internet.

The educational institutions provide a financial payment for access to the prospective student pool. This payment would take the form of a discount from the proposed tuition cost, a fee, or incentive bonuses for increasing enrollments in specific target programs. The prospective students would be required to pay a registration fee to access the pool of educational institutions that are offering discounted tuition rates. Thus, the method and system allows matching of prospective students to educational institutions offering discounted tuition rates. The students are provided with cost effective education and the educational institutions optimize enrollment through offering discounted tuition rates. Financial return from enrollments for the educational institutions is maximized by the increase of enrollment due to the discounted tuition rate and access to a pool of prospective students.

These aspects and other objects, features, and advantages of the present invention is described in the following Detailed Description which is to be read in conjunction with the accompanying drawings.

### BRIEF DESCRIPTION OF THE DRAWINGS

FIG. 1 is a schematic block diagram depicting one embodiment of the present invention;

FIG. 2 is a schematic block diagram depicting one example of system of FIG. 1;

FIG. 3 is a schematic block diagram illustrating one example of the controller within the system of FIG. 2;

FIG. 4 is a schematic flow diagram depicting one example of the process used in the system of FIG. 1;

### DETAILED DESCRIPTION

The present invention relates to a method and system (hereinafter referred to as the “Plan”), which facilitates interaction between prospective students seeking cost effective solutions for formalized education and educators that are interested in optimizing their enrollments. The principles of the invention can be understood with reference to a system that matches prospective students to post-secondary schools offering discounted tuition rates. The schools offer discounted tuition rates in return for a listing of the pool of prospective students that can be used to boost enrollment. The post-secondary schools include, but are not limited to, private schools, post-secondary school, undergraduate, graduate, post graduate and PhD/doctorate programs typically at universities and colleges. Also included are executive management programs, continuing education programs, and trade/vocational schools. The prospective students can register with the Plan of the present invention either directly or indirectly. For example, individual students may register with the Plan directly to access the pool of schools offering discounted tuition. The prospective student may also register indirectly like in the example of employer sponsored educational programs, employer associations or other special interest groups and the like.

In one embodiment, the present invention functions by having the prospective students (hereinafter referred to as “Members”) register and provide pertinent applicant information. This communication may be accomplished via the Internet or other conventional means. Applicant information would include, for example, questions related to the interest of the Member and those that are typically requested by educators to determine the eligibility of the Member. Educators who are interested in participating (hereinafter referred to as “Network Schools”) would also register with the Plan and provide pertinent information regarding applicant prerequisites, availability of capacity and a proposed tuition cost. Depending on the implementation, the individual identity of the Member may or may not be made known to the Network School until after the Member had been qualified as eligible by the match of applicant information and Network School requirements.

In one implementation, Network Schools pay a financial payment for access to the prospective Member pool. Access to the pool of Members would allow the Network Schools to boost enrollment. Payment for this access could take the form, for example, of percentage discount from the proposed tuition cost, a fee, or incentive bonuses for increasing enrollments in specific target programs. The Member may also pay a registration fee for access to the prospective pool of Network Schools offering discounted tuition rates. These fees could be applied towards furthering discounted tuition rates from the Network Schools. Additional charges maybe made to indirect Members, such as employers, that require utilization reporting ands administration requirements.

One advantage of the present invention is that it matches supply and demand needs for learning programs for those participating in the Plan such as Members and Network Schools. In addition, the present invention provides cost effective education and optimization of enrollment through offering discounted tuition rates. Financial return from enrollments for the educational institutions is maximized by the increase of enrollment due to the discounted tuition rate and access to a pool of prospective students.

In another variant, Members that participate via indirect buying organizations may have fees that are retrospectively rated to be consistent with assumed baseline utilization. For example, employers may pay a fixed annual fee based upon a guaranteed number of employees that will participate in the Plan. Network schools, in one implementation, may have tuition discounts that are tiered depending on the number of students enrolled. Advertising revenue from the network schools, related ancillary product or service providers may be advertised via a banner on a controller's Web page. Related providers could also make their products and services available at discounted rates and be made accessible to Members. For example, vendors of school supplies may be advertised.

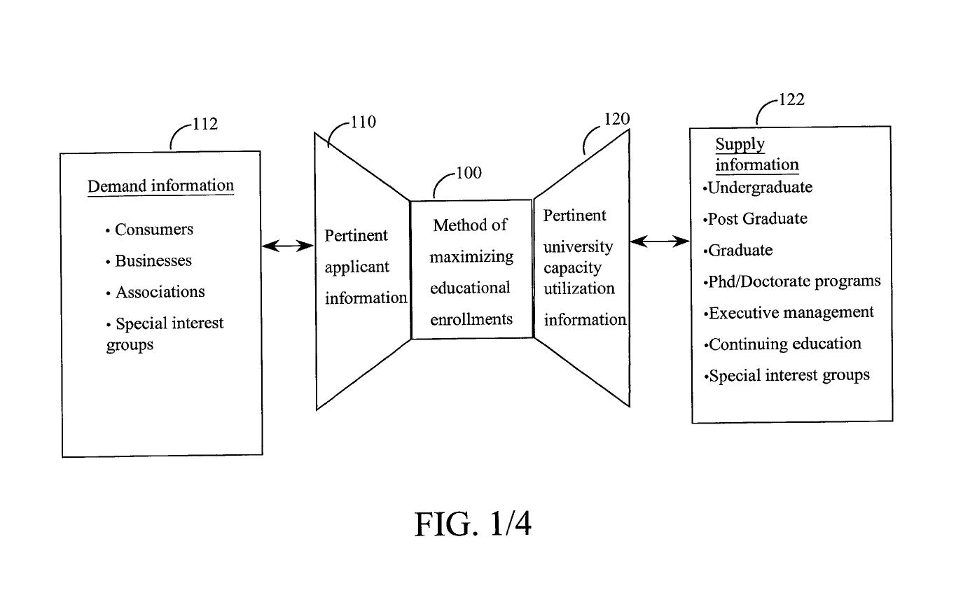

Referring to the drawings, shown in FIG. 1 is a schematic block diagram representing an example of the implementation of the Plan. Block 100 illustrates the method of maximizing enrollments. Preferably, this method includes offering discount tuition in exchange for access to a pool of prospective students. Block 110 illustrates the filtering of pertinent applicant information from block 112. Block 112 includes demand information from the Members which includes but is not limited to information from consumers, businesses, associations and special interest groups. The information supplied by these parties is filtered to match information supplied by the Network Schools.

Block 122 illustrates supply information from the Network Schools. Depending on the implementation, this information may also be filtered to match unfiltered or filtered demand information from the Members. Block 120 represents pertinent information from the Network Schools which include but is not limited to capacity, proposed tuition cost, proposed discount tuition cost, availability in enrollment and the like.

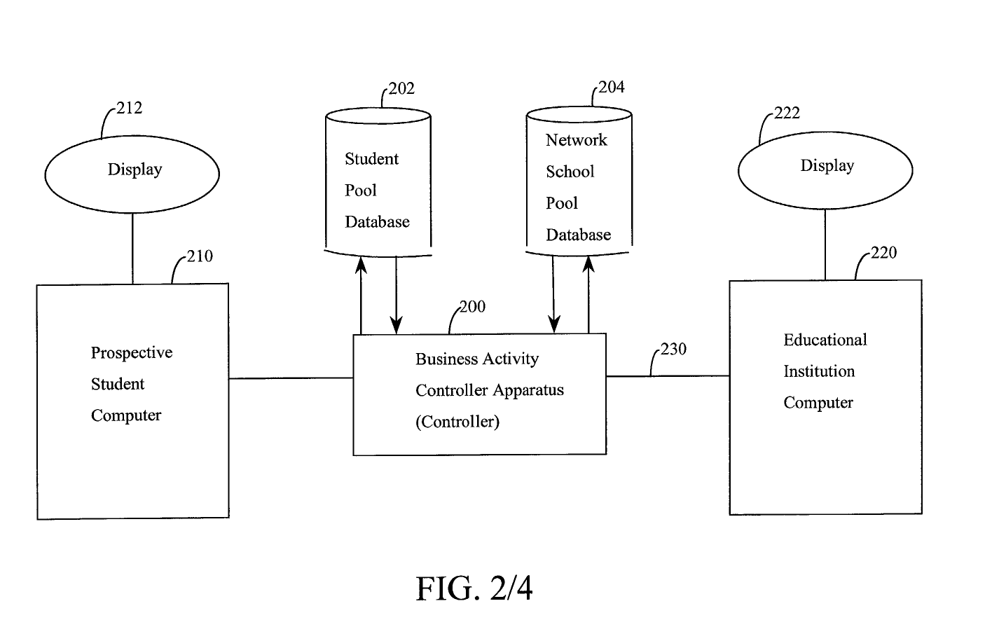

FIG. 2 illustrates one implementation of the system in FIG. 1. Block 200 illustrates a business activity controller apparatus or controller. Controller 200 may be a computer, a server, a Web site, a processor, a network, or any combination thereof. Controller 200 is in communication with a prospective student computer 210 by a link 230. The link 230 is preferably an Internet connection, but maybe any type of communication link known to those skilled in the art. Computer 210 has a display 212 for displaying information from the controller 200.

The controller 200 is also in communication with an educational institution computer 220 by link 230. Computer 220 also has a display 222, which is used to display information from the controller. The controller is further in communication with at least one database containing information concerning the Members and Network Schools. Shown in this implementation in FIG. 2 are two databases, although one may be used as well. Block 204 depicts a Network School pool database. Database 204 contains a listing of Network Schools registered to use the Plan implemented by the controller 200. In addition, database 204 contains information such as the prerequisites of enrollment, tuition costs, and the like for each respective Network School. Block 202 illustrates a student pool database. Database 202 includes a listing of registered Members with information concerning each individual Member. The information includes such data as formalized entrance exam scores, and other enrollment data. Both databases are in communication with the controller 200. Controller 200 matches and compares data from database 202 and database 204. Depending on the implementation, prerequisites from the network School are matched with the data from the pool of Members to determine eligibility of enrollment. The Member's identity may or may not be given to the Network School as previously described. Notification is given to the Network School and/or members of the eligibility of enrollment. The Network School benefits by boosting enrollment from access to the pool of eligible Members for payments previously described. The Members benefit by obtaining a cost effective education through the discounts offered by the Network Schools.

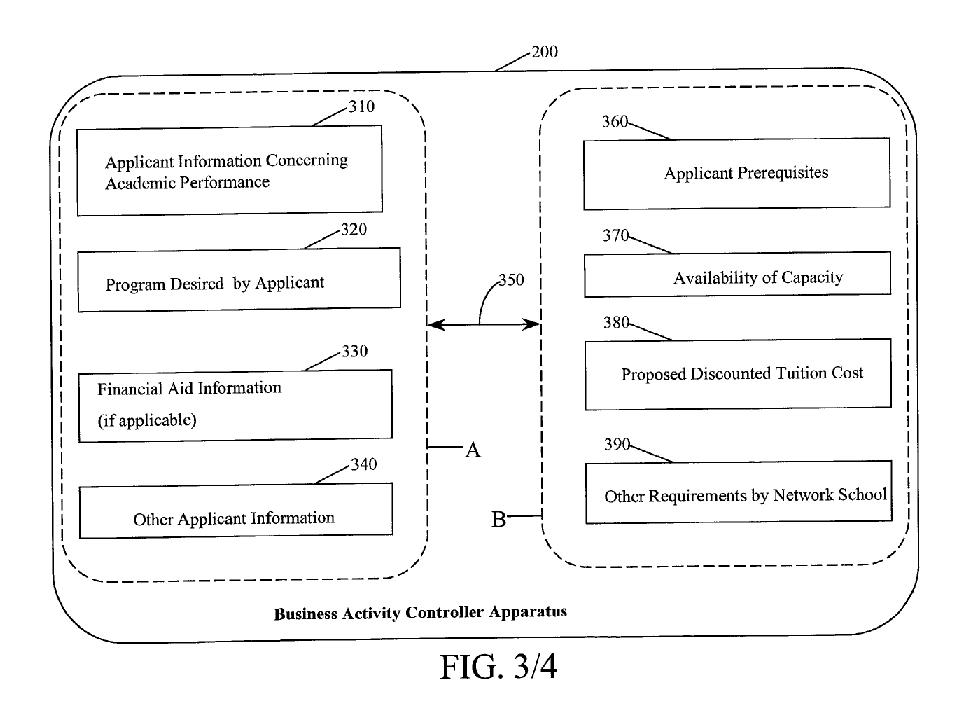

FIG. 3 illustrates one embodiment of controller 200. Shown is the comparison of data “A” with data “B” by logic represented by arrows 350. The logic 350 contained in controller 200 allows the matching of data from two pools of registered applicants, namely Members and Network Schools respectively. Member data “A” may include, for example, applicant information concerning academic performance shown in block 310. Block 320 represents information on the program desired by the applicant Member. Bloc 330 represents financial aid information and block 340 represents other applicant information. Depending on the implementation of the Plan, certain blocks of data may or may not be used in the comparison. For example, financial aid information may not be used in the comparison.

Network School data “B” may include, for example, applicant prerequisites as shown in block 360. Block 370 represents availability or capacity of the school for enrollment. Block 380 represents proposed discounted tuition cost and block 390 represents other requirements by the Network School. As with data “A” some fields of data may or may not be used in the comparison between the members and Network Schools.

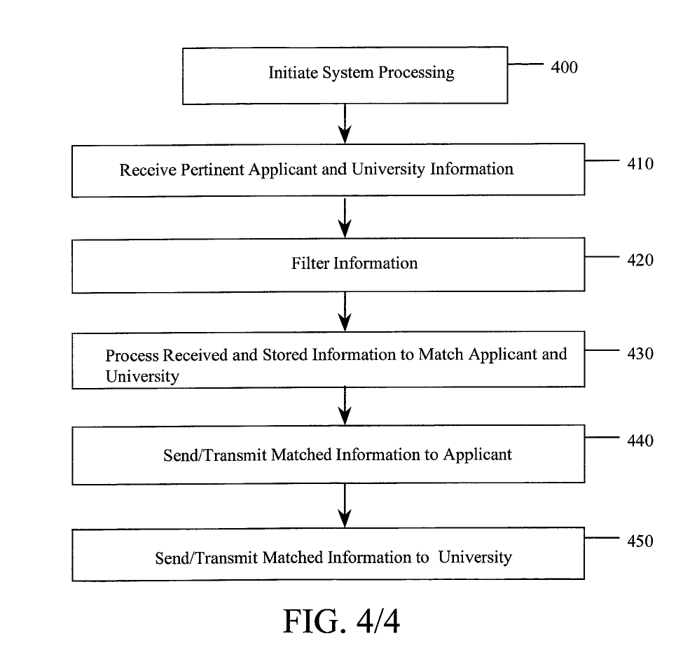

FIG. 4 illustrates one implementation of the flow path in the Plan. Block 400 illustrates the initiation of the system processing. Typically, this initiation includes some registration process. Block 410 depicts receiving pertinent applicant and university information as previously described. Block 420 demonstrates a filtering process which involves filtering information only necessary for the comparison. Such filtering may include for example, comparing only that data that refers to formalized entrance examination scores. Block 430 illustrates matching stored and received filtered data to match prospective students to universities per the prerequisites previously set. Block 440 and block 450 demonstrate communicating to the applicant Member and University/Network School concerning the results of the matching.

It should be understood that the above description is only representative of illustrative examples of embodiments and implementations. For the reader's convenience, the above description has focused on a small representative sample of all possible embodiments, a sample that teaches the principles of the invention. Other embodiments may result from a different combination of portions of different embodiments. The description has not attempted to exhaustively enumerate all possible variations.

Alternate embodiments may not have been presented for a specific portion of the invention, and may result from a different combination of described portions, or that other undescribed alternate embodiments may be available for a portion, is not to be considered a disclaimer of those alternate embodiments. It is appreciated that many of those undescribed embodiments are within the literal scope of the following claims, and others are equivalent. It is recognized that the order or sequence of tasks illustrated can be in any order to achieve the desired end result of matching Members to Network Schools offering discounted tuition with the advantages previously discussed. The above description is illustrative of features that may be combined or individually utilized in the maximizing of enrollments.

What is claimed:

1. A method of maximizing educational enrollments, comprising:
(a) generating a database containing a plurality of Members in communication with a controller; and
(b) receiving data at said controller on at least one Network School offering a discounted tuition rate in exchange for access to said Members.

2. The method of claim 1, further comprising matching said Members with said Network School based upon prerequisites determined by said Network School.

3. The method of claim 1, wherein said Members include at least one individual student, employer, employer sponsored educational program, employer associations or other special interest group.

4. The method of claim 1, wherein said Network School includes at least one private school, post-secondary school, under graduate school, graduate school, post graduate school, doctorate programs, executive management programs, continuing education programs, or trade/vocational school.

5. The method of claim 1, further comprising generating a database containing at least one Network School.

6. The method of claim 5, wherein said database further includes data further comprises data relating to at least one of a set of prerequisites for enrollment into said Network School, availability of capacity, proposed discounted tuition cost, or proposed tuition cost.

7. The method of claim 1, further comprising transmitting displaying a list of said Members to said Network School.

8. A method of maximizing educational enrollments, comprising:
(a) generating a database containing a plurality of Members in communication with a controller;
(b) receiving data at said controller on at least one Network School in exchange for a payment; and
(c) matching said Members with said Network School based upon prerequisites determined by said Network School.

9. The method of claim 8, wherein said payment comprises at least one of a percentage discount from a proposed tuition cost, a fee, or an incentive bonus for increasing enrollments in specific target programs.

10. A method of maximizing educational enrollments, comprising:
(a) generating a database containing a plurality of Members in communication with a controller;
(b) receiving data at said controller on at least one Network School offering a discounted tuition rate in exchange for access to said Members;
(c) matching said Members with said Network School based upon a set of prerequisites determined by said Network School
(d) transmitting a list to said Network School, said list containing said Members which match said prerequisites; and
(e) notifying said Members concerning the status of inclusion on said list.

11. A method of maximizing educational enrollments, comprising:
(a) receiving registration information from at least one Member at a controller;
(b) receiving registration information from at least one Network School at said controller;
(c) generating a database containing said information from said Member;
(d) generating a database containing said information from said Network School offering a discounted tuition rate in exchange for access to said Member;
(e) comparing said Member database with said Network School database based upon a set of prerequisites determined by said Network School;
(f) transmitting a list to said Network School, said list containing said Members in said Member database which match said prerequisites; and
(g) notifying said Members concerning the status of inclusion on said list.

12. The method of claim 11, wherein said Member registration further comprises receiving a payment from said Member.

13. The method of claim 11, wherein said discounted tuition rate tuition is tiered depending on the number of said Members enrolled at said Network School.

14. The method of claim 11, further comprising transmitting advertising material to said Members, said advertising material related to ancillary product or service providers.

15. A method of maximizing educational enrollments, comprising:
(a) receiving data at said controller on at least one Member; and
(b) generating a database containing at least one Network School offering a discounted tuition rate in exchange for access to said Members.

16. A system for maximizing educational enrollments, comprising:
a memory device; and
a processor in communication with said memory device and configured to generate a database containing a plurality of Members in communication with a controller; receive data at said controller on at least one Network School offering a discounted tuition rate in exchange for access to said Member; and match said Members with said Network School based upon prerequisites determined by said Network School.

17. The system of claim 16, further comprising a link connecting the processor to a Network School computer for display of a list of said Members.

18. The system of claim 16, further comprising a link connecting the processor to a member computer for display of a list of said Network Schools.

19. A system for maximizing educational enrollments, comprising:
means for generating a database containing a plurality of Members in communication with a controller;
means for receiving data at said controller on at least one Network School offering a discounted tuition rate in exchange for access to said Members; and
means for matching said Members with said Network School based upon prerequisites determined by said Network School.

20. The system of claim 19, further including means for transmitting registration information in response to a login request.

21. A computer readable medium for use in providing a system for maximizing educational enrollments, comprising:
an instruction code for generating a database containing a plurality of Members in communication with a controller;
an instruction code for receiving data at said controller on at least one Network School offering a discounted tuition rate in exchange for access to said Members; and
an instruction codes for matching said Members with said Network School based upon prerequisites determined by said Network School.
